(19) United States
(12) Patent Application Publication
(10) Pub. No.: US 2002/0184807 A1
(43) Pub. Date: Dec. 12, 2002

(54) Ready Swipe

(76) Inventor: Valerie R. Lopez, Teaneck, NJ (US)

Correspondence Address: Valerie R. Lopez, 121 Herrick Avenue, Teaneck, NJ, 07666, US

(21) Appl. No.: 09/859,322

(22) Filed: May 18, 2001

Related U.S. Application Data
(60) Provisional application No. 60/241,960, filed on Oct. 23, 2000.

(51) Int. Cl. G09F 3/18; G09F 3/20

(52) U.S. Cl. 40/661; 40/654.01

(57) ABSTRACT

A precisely sized transparent cardholder for two fare zone commuters that use both bus pass and magnetic strip subway card simplified into one cardholder. The use of a Poly Vinyl Chloride with 0.13 mm thickness makes this design possible and to properly form the two pockets into one cardholder. The transparent cardholder consist of three transparent panels: (i) front panel, (ii) inner dividing panel, and (iii) the back panel. The front panel is sealed to the inner dividing panel from the left side, right side and the bottom as to form the larger pocket for the insertion of the bus pass. The back panel is sealed ¾″ up from the bottom to the inner dividing panel and sealed from the left side and right side as to form the smaller pocket for the insertion of the magnetic strip subway card. The smaller pocket is specifically designed that plastic does not overlap the magnetic strip. The opening for both the larger pocket and the smaller pocket on the top are equally leveled and sized.

### BACKGROUND OF THE INVENTION

I have invented a precisely sized transparent cardholder for two fare zone commuters that use both bus pass and magnetic strip subway card simplified into one cardholder. No more frantic moments of being unable to locate either cards. It is the convenience and organization of the transparent cardholder that will save time for hurried commuters.

The design accomplishes three main reasons of my inventing the product:

First, the transparent plastic used to make the design is a Poly Vinyl Chloride with a precise thickness of 0.13 mm. The idea of using this type of thickness at 0.13 mm for the plastic is that: (i) it allows the design to properly form two pockets into one; and (ii) it allows the plastic to swipe through the turnstile with ease without taking the magnetic strip subway card or bus pass out of its holder.

Second, the front panel is sealed left, right and bottom to the inner dividing panel, leaving the top open, thus creating the larger pocket for the insertion of the bus pass.

Third, the back panel is sealed left, right and precisely sealed 3/4″ Up from the bottom to the inner dividing panel, leaving the top open, thus creating the smaller pocket for the insertion of the magnetic strip subway card. The design of the smaller pocket enables the magnetic strip of the subway card to be exposed and above the top opening to easily swipe the magnetic strip through the turnstile. (See, FIG. 4 for illustration)

A slight thickness above 0.13 mm or if the plastic overlaps the magnetic strip from the smaller pocket would disable the design of the product to work properly.

Commuters no longer have to take: (i) the bus pass out of its transparent larger pocket, commuter simply shows the bus driver their bus pass, thus easing the flow of the passengers in and out of the bus; and (ii) the magnetic strip subway card out of its transparent smaller pocket, the magnetic strip is free and open of any plastic, as the commuter swipes the magnetic strip subway card through the turnstile with ease. The only time a commuter ever has to take the bus pass and magnetic strip subway card out of its holder is for monthly, weekly, daily, etc. renewal.

Although the present invention is made to hold a bus pass and subway card, there are other uses for the cardholder. For example, it can be used to hold a driver's license and credit card. Such a cardholder is advantageous to stores using credit cards that require a picture I.D. Other uses for the transparent cardholder are for companies that require picture I.D. that use either a card with bar code or a card with a magnetic strip for entering secured areas.

### BRIEF SUMMARY OF THE INVENTION

My present invention is a precisely sized transparent cardholder for two fare zone commuters that use both the bus pass and magnetic strip subway card. The transparent cardholder simplifies two fare zone passes into one cardholder. The convenience and organization of the transparent cardholder will save time for hurried commuters.

The product accomplishes its design for three reasons: (i) the use of Poly Vinyl Chloride with a thickness of 0.13 mm; (ii) by sealing the left side and right side and precisely sealing 3/4″ up from the bottom of the inner dividing panel to the back panel forms the smaller pocket. The smaller pocket is also design to keep any plastic from overlapping the magnetic strip of the subway card, thus swiping through the turnstile with ease; and (iii) as the front panel and inner dividing panel are sealed left, right and bottom it forms the larger pocket which holds the bus pass in its full size protecting it from any wear and tear and/or damage. Also, the top opening of each pocket is equally leveled and sized.

The present invention will be more apparent from the description, claim and drawings discussed below.

### BRIEF DESCRIPTION OF THE DRAWINGS (IF FILED)

FIG. 1 Shows the front view of the larger transparent pocket that holds the bus pass.

FIG. 2 Shows the top section of the left side view of the holder. This view shows the inner dividing panel separating the front panel from the back panel.

Shows the top section of the right side view of the holder. This view shows the inner dividing panel separating the back panel from the front panel.

FIG. 3 Shows the back view of the smaller transparent pocket that holds the magnetic strip subway card.

FIG. 4 The full back view of the smaller pocket illustrating the magnetic strip subway card exposed.

The transparent cardholder consists of a front panel, inner dividing panel, and back panel. The larger pocket is sealed on the left side, right side, and the bottom with an opening on the top. The smaller pocket is sealed on the left side, right side and 3/4″ up from the bottom to the inner dividing panel.

### DETAILED DESCRIPTION

The present invention relates to a cardholder for commuters who commute in two fare zone regions. The cardholder is specifically sized and designed to carry its bus pass and magnetic strip subway card into one cardholder. It is designed to hold these passes without having to take either card out of its holder.

Number Description

#1 Top opening of larger pocket.

#2 Larger pocket with measurements of 3½″×2¼.

#3 Inner Dividing Panel.

#4 Front Panel.

#5 Opening of larger pocket.

#6 Back Panel.

#7 Opening of smaller pocket.

#8 Top opening of smaller pocket.

#9 Smaller pocket with measurements of 3½″×1½.

#10 Back panel sealed 3/4″ up from the bottom of the inner dividing panel.

#11 Full back view of the smaller pocket.

FIG. 1 shows the front view of the transparent cardholder that holds the bus pass. #1 is the top opening of the transparent cardholder. #2 shows the transparent cardholder has precise measurements of 3½″×2¼″, thus creating the larger pocket for the insertion of the bus pass into its holder. The transparent plastic is used because it allows the commuter to show the bus pass to the bus driver—thus eases the flow of commuters into the bus.

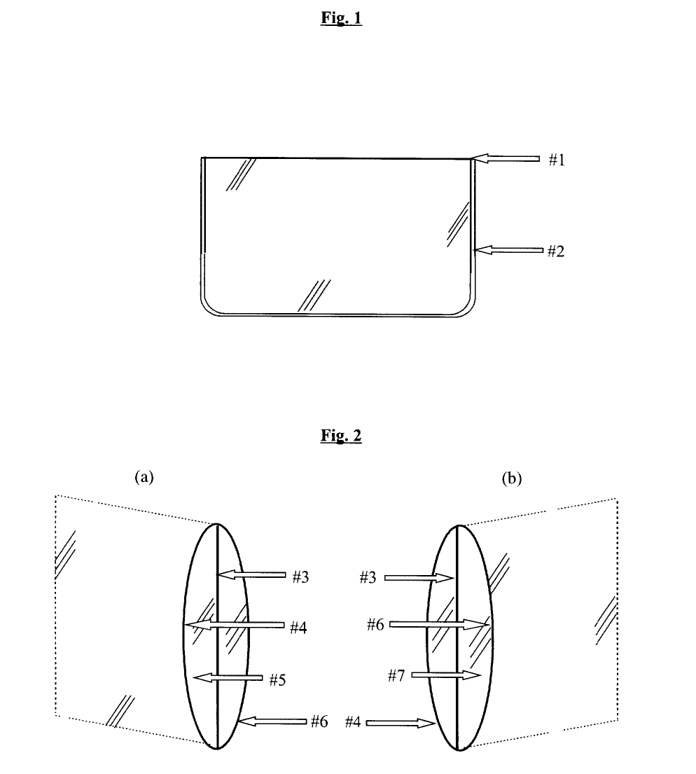

FIG. 2 shows the top section of the left side view of the transparent cardholder. #3 shows the inner dividing panel separating the #4—front panel from the #6—back panel. FIG. 2(a) also shows that by putting the #4—front panel together with the #3—inner dividing panel by sealing the left side, right side and bottom side, leaving the #5—top open thus creates the larger pocket for the insertion of the bus pass.

FIG. 2 also shows the top section of the right side view of the transparent cardholder. #3 shows the inner dividing panel separating the #6—back panel from the #4—front panel. FIG. 2(b) also shows that by putting the #6—back panel together with the #3—inner dividing panel and by sealing the left side, right side and 3/4″ up from the bottom, leaving the #7—top open creates the smaller pocket for the insertion of the magnetic strip subway card.

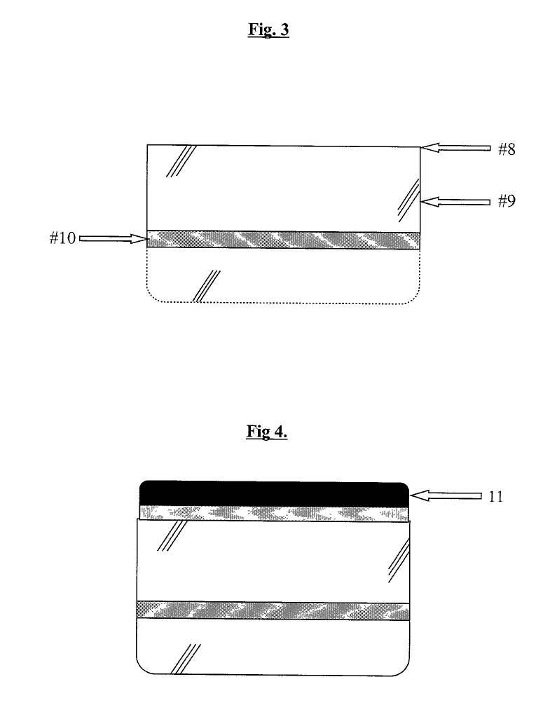

FIG. 3 shows the back view of the transparent cardholder that holds the subway card. #8 is the top opening of the transparent cardholder. #9 shows the transparent back panel that has precise measurements of 3½″×1½″. #10 shows the sealed portion measuring from the bottom 3/4″ to the inner dividing panel, thus creating the smaller pocket.

FIG. 4 shows the full back view of the smaller pocket. #11 illustrates back view of the smaller pocket showing the magnetic strip exposed over the smaller pocket.

Referring to FIG. 1 of #1 and FIG. 3 of #8, the top opening of each card are equally leveled and sized.

I claim:

1. A transparent cardholder for two fare zone commuters to organize a bus pass and magnetic strip subway card into one cardholder comprising of:
(a) The use of a Poly Vinyl Chloride plastic with a thickness of 0.13 mm; and
(b) Three transparent panels: (i) a front panel, (ii) an inner dividing panel, and (iii) back panel.

2. A transparent larger pocket said to hold the bus pass is formed in the following:
(a) The larger pocket in claim 2, wherein the measurements is 3½″×2¼″;
(b) The front panel and inner dividing panel are sealed on the left side, right side and bottom side as to form the larger pocket; and
(c) The larger pocket in claim 2, wherein said opening is on the top for the insertion of the bus pass.

3. A transparent inner dividing panel said to separate the bus pass and magnetic strip card.
(a) The inner dividing panel in claim 3, wherein the measurements is 3½″×2¼″.

4. A transparent smaller pocket said to hold the magnetic strip subway card.
(a) The smaller pocket in claim 4, wherein the measurements is 3½″×1½″;
(b) The smaller pocket in claim 4, wherein the back panel is sealed 3/4″ up from the bottom to the inner dividing panel and also sealed on the left side and right side so as to form the smaller pocket; and
(c) The smaller pocket in claim 4, wherein said opening is on the top for the insertion of the magnetic strip.

5. That each card pocket have a top opening equally leveled and sized for the insertion of the bus pass and magnetic strip subway card.
